(19) United States
(12) Patent Application Publication
(10) Pub. No.: US 2024/0002118 A1
(43) Pub. Date: Jan. 4, 2024

(54) FIBROUS CONTAINERS FOR OVENABLE PRODUCTS

(71) Applicant: DuPont Teijin Films U.S. Limited Partnership, Wilmington, DE (US)

(72) Inventors: Mark Dawes, Wilton (GB); Erik Nelson, Chester, VA (US); Stephen Franzyshen, Chester, VA (US)

(73) Assignee: DuPont Teijin Films U.S. Limited Partnership, Wilmington, DE (US)

(21) Appl. No.: 18/026,706

(22) PCT Filed: Aug. 22, 2021
(86) PCT No.: PCT/GB2021/052456

§ 371 Date: Mar. 16, 2023

(30) Foreign Application Priority Data
Sep. 23, 2020 (GB) 2015009.0

(51) Int. Cl. B65D 65/40; B32B 27/10; B32B 27/12; B32B 27/36; B32B 1/02; B32B 7/035; B32B 37/06

(52) U.S. Cl. CPC B65D 65/40; B32B 27/10; B32B 27/12; B32B 27/36; B32B 1/02; B32B 7/035; B32B 37/06; B32B 2250/03; B32B 2307/308; B32B 2307/31

(57) ABSTRACT

A laminate and a method for preparing a laminate are provided. The method comprises the steps of providing a container or sheet which comprises a fibrous material, disposing a primer composition onto at least one surface of the container or sheet to form a primer layer on the container or sheet, and also disposing a polymeric liner film onto a surface of the primer layer to form a lined container or sheet. The primer composition comprises at least one sulfopolyester.

The present invention relates to laminates comprising fibrous sheets or containers which are lined with a polymeric film, and methods for producing such laminates. The laminate is particularly suitable for packaging applications, particularly for forming a sealed package with a product encapsulated therein. The present invention also relates to the sealed packages, to methods for producing such packages, and to the components used to prepare the laminates and the sealed packages.

A common type of food packaging comprises a container and a lid which securely seals the container. Containers suitable for perishable products (such as foodstuffs) are commonly in the form of trays or receptacles that, when sealed with a lid (such as transparent “lidding film”), prevent leakage and drying-out of the packaged contents, and which provide a protective barrier against insects, bacteria and air-borne contaminants during storage. Containers made from plastic materials, such as polymers, are widely used for packaging convenience foods, such as ready-prepared ovenable meals which are warmed either in a microwave oven or in a conventional oven. Also known are “dual-ovenable” containers which may be warmed in either a microwave or a conventional oven. Plastic containers are typically formed of polyester(s) (such as polyethylene terephthalate (PET)) and/or polyolefins (such as polypropylene (PP) or polyethylene (PE)). The plastic containers may be coated with materials to provide an improved barrier to oxygen and/or moisture. A container in widespread use for ovenable meals is an APET/CPET container, which is made up of an amorphous PET (APET) layer on top of a crystalline PET (CPET) layer and which provides enhanced sealing and barrier properties.

The term “container” as used herein refers to any receptacle or tray suitable for disposing the goods to be packaged. A film which forms a lid on such a container is referred to herein as a lidding film. Lidding films are typically made from composite films comprising a flexible polymeric substrate and a heat-sealable polymeric layer. The manufacture of sealed containers using lidding films involves the formation of a seal between the lidding film and the container. This seal is formed by placing the lid on top of the container and applying heat and pressure in order to soften or melt the sealable coating layer so that it adheres to the surface of the container and forms an effective seal between the lid and the container. Polyester films (such as PET films) have been used as lidding films for plastic containers. A good bond can be formed between the plastic container and the polyester film because these materials typically have similar properties.

Containers made from compatible (e.g. chemically similar) polymers can typically be recycled. The polymeric containers can be shredded and processed in a pelletizing extruder to make recycled pellets of polymer. The pellets can be mixed with fresh or virgin polymer, and the mixture can be re-melted and re-extruded to produce other products. However, it is difficult to recycle polymeric containers that comprise materials which are not compatible (e.g. which are not chemically similar) as the recycled pellets (and products made from them) tend to degrade and discolour to an unacceptable degree. Accordingly, plastic containers made from compatible materials are preferred because it is possible to recover waste material by recycling the entire container without having to separate the different materials. The term “recycling” as used herein means reuse of the material in the same or a similar process. The term “recyclable” as used herein means that the recycled material is suitable for use in proportions of up to 100% by weight in the product using the recycled material.

Plastic containers are perceived as less environmentally acceptable. There remains a need for alternative containers. Containers formed from fibrous materials can be readily produced from recyclable, sustainable and/or environmentally friendly sources. Furthermore, containers made from natural fibres may readily biodegrade. However, fibrous containers are porous, tend to leak and have poor barrier properties, which may lead to food spoilage and growth of micro-organisms. In addition, the interior of fibrous containers may stick to the packaged contents. These disadvantages may be addressed by lining the container with a polymeric film. Such polymeric films are referred to herein as “liner” films, and are typically made from films comprising a flexible polymeric substrate and optionally a sealable polymeric layer (for example, a heat-sealable layer). The manufacture of sealed containers using liner films requires that the liner film and the container can bond well together, i.e. such that the lined container does not delaminate in use and maintains an effective seal for the packaged contents. This bond can be formed by disposing the liner film on a surface of the container, and applying and/or pressure (positive or negative), for instance in a thermoforming step, to bond the liner to the interior surface of the container to form a laminated lined container tray having the desired barrier and/or sealing properties. However, it has been difficult to achieve good adhesion directly between a fibrous material and a polymeric liner film. Attempts have been made to improve the adhesion strength using conventional primer materials applied to the surface of fibrous sheets, but these have been found to be unsuitable since there are typically absorbed too deeply into the fibrous structure, and hence insufficiently present at the surface of the fibrous sheet, leading insufficient bond strength between the fibrous material and the polymeric liner film. There remains a need to provide a fibrous container comprising a liner film which exhibits improved barrier properties and improved bond strength between the liner and the fibrous container so that it does not delaminate during use.

Furthermore, the lined containers should be readily recyclable, which means that the polymeric liner film should be easily separable from the fibrous container after use and during recycling, without leaving residue of the fibrous container on the liner film and vice versa, thereby enabling the components of the lined container to be easily separated into different waste streams during recycling. If the bond strength between the liner film and the fibrous container is too strong, then the liner film cannot be readily removed after use. For instance, the liner film may tear There remains a need to provide lined fibrous containers such that the bond strength between the liner film and the fibrous container is balanced to (a) achieve durability and resistance to delamination during use, and (b) facilitate removability of the liner film after use during a recycling process.

It would be particularly desirable to provide lined fibrous containers wherein the seal between the container and the liner film is hermetic. A hermetic seal acts a barrier to prevent substantial passage of gases such as air and/or oxygen. Thus, it is desirable that the sealed package (i.e. the lined fibrous container sealed with a lidding film) should encapsulate a product hermetically. Hermetically sealed containers can be flushed with inert gas during packing of the product to extend shelf life. Hermetic seals eliminate leaking and afford high burst strength enabling ease of distribution without compromising the integrity of the sealed package. An hermetic seal is able to reduce loss of moisture, reduce ingress of oxygen (which can otherwise lead to rancidity) and/or prevent freezer burn. The liner film can also prevent baked goods from sticking to the fibrous container and/or prevent an off-taste being imparted into the food during cooking.

Primers for improving the adhesion of PET to paperboard are known in the art. For instance, US-2004/161601-A and US-2008/145653-A (International Paper) describe primers formulated to enhance adhesion of a PET coating to a clay coated paperboard of high starch content. The primers are: an ammonium catalyzed, self-crosslinking copolymer of ethylene-vinyl acetate with N-methylol acryl amide functional groups attached to the polymer backbone; and/or epoxy modified polyolefin. The primers are provided with functional groups designed to form a strong adhesive bond between clay coated paperboard and PET to produce a durable laminate. The primer is designed primarily to resist delamination and hence the PET layer is not readily peelable from the paperboard, and therefore not easy to recycle. The primer is not designed for use with paperboard without a clay coating.

It is an object of the present invention to address one or more of the aforementioned needs in the art.

According to a first aspect of the present invention, there is provided a method for preparing a laminate, the method comprising the steps of:
a) providing a container or sheet (A) which comprises a fibrous material;
b) disposing a primer composition onto at least one surface of the container or sheet to form a primer layer (B) on the container or sheet, wherein the primer composition comprises at least one sulfopolyester;
c) disposing a polymeric liner film (C) onto a surface of the primer layer (B), to form a lined container or sheet,
d) where a lined sheet is obtained from step c), optionally forming (preferably thermoforming) a lined container from the lined sheet.

Where step (a) is the provision of a sheet, steps c) and d) may be performed sequentially or substantially simultaneously.

Preferably, step d) is effected by thermoforming, preferably vacuum thermoforming, according to conventional techniques and using commercially available equipment.

In the thermoforming process, a raised outer portion and an indented central portion for receiving the product is provided in the sheet by the application of heat and pressure (positive or negative) such that the sheet substantially assumes the general shape of a container. Thus, preferably the container has a conventional shape such that the raised outer portion is in the form of a flange or rim which projects from the walls of the container such that said flange or rim is configured to be bonded to a lidding film in order to seal the container and form a package. The indented central portion preferably takes the form of a base and walls which extend between the base and the raised outer portion.

In a preferred embodiment of the method, the fibrous sheet is in the form of a planar (or 2-dimensional) net which when folded produces the 3-dimensional shape of the container. In a preferred thermoforming process, the planar net is placed in or on the cavity in the thermoforming apparatus (wherein said cavity corresponds to the desired shape of the container), preferably wherein the primer composition has already been disposed on one surface of the fibrous sheet (step (b)) such that said surface is the surface which will face towards the interior of the container once it has been formed. In step (c) of the process the polymeric liner film is disposed on the primed surface of the fibrous sheet, and in step (d) the 3-dimensional shape of the lined container is created from the 2-dimensional fibrous sheet by application of heat and pressure (positive or negative) thereby effecting the thermoforming of the polymeric liner film simultaneously with the creation of the shape of the container, and preferably also simultaneously with the bonding of the polymeric liner film to the primed fibrous sheet.

In a particularly preferred embodiment of the method, the primed fibrous sheet in the form of a planar net is located within the cavity in the thermoforming apparatus such that the sheet assumes the 3-dimensional shape of the container by applying pressure thereto (positive or negative pressure). The polymeric liner film is then disposed on or in the cavity and heat and pressure applied to the polymeric liner film in a thermoforming step such that the polymeric liner film is contacted with the primed fibrous sheet in the cavity, said thermoforming step simultaneously thermoforming the polymeric liner film to configure it to the shape of the container and creating a bond between the polymeric liner film and the primed fibrous sheet.

In the embodiments where the fibrous sheet is initially in the form of a planar net, the lamination of the polymeric liner film thereto increases the rigidity of the container and allows the container to maintain its shape.

In another preferred embodiment of the method, the desired shape of the container is already present and step (b) comprises disposing the primer composition onto a surface thereof. In this embodiment, the polymeric liner film is preferably disposed on the primed surface of the fibrous container using a thermoforming technique as described herein. Thus, the container is disposed in the cavity of the thermoforming apparatus, and the polymeric liner film is then disposed on or in the cavity and heat and pressure (positive or negative) applied to the polymeric liner film in a thermoforming step such that the polymeric liner film is contacted with the primed fibrous container in the cavity, said thermoforming step simultaneously thermoforming the polymeric liner film to configure it to the shape of the container and creating a bond between the polymeric liner film and the primed fibrous sheet.

Thus, where a container is provided in step (a) of the method, step (c) is preferably effected by such a thermoforming step, and preferably a thermoforming step in which the polymeric liner is simultaneously bonded to the primed container.

According to a second aspect of the present invention, there is provided a laminate comprising a container or sheet (A), a primer layer (B) disposed on at least one surface of the container or sheet, and a polymeric liner film (C) disposed on the primer layer, wherein the container or sheet (A) comprises a fibrous material and wherein primer layer (B) is derived from a primer composition comprising at least one sulfopolyester.

The laminate is therefore a lined fibrous container or a lined fibrous sheet. The laminate of the second aspect may be obtained from the method of the first aspect of the invention.

As described hereinabove, the lined sheet can be formed into a container for use as component of a sealed package. The lined sheet may be prepared separately and then formed into container (i.e. so that these steps are sequential) or the lining step and container-forming step may occur effectively substantially simultaneously, simultaneously being preferred. Thus, it is preferred that the lined container is formed by thermoforming the polymeric liner film (C) and bonding said liner film to the primed fibrous sheet substantially simultaneously. Thermoforming the polymeric liner film (C) helps create and maintain the shape of the lined container (for example, when forming the container from a pre-cut blank of fibrous sheet).

The laminate comprises three layers and has an ABC-layer structure. In this embodiment, the polymeric liner film (C) is disposed on the primer layer (B) and the primer layer (B) is disposed on the container or sheet (A). Thus, polymeric liner film (C) is in direct contact with primer layer (B); container or sheet (A) is in direct contact with primer layer (B); and primer layer (B) is in direct contact with both the polymeric liner film (C) and the container or sheet (A).

When the laminate is used as a packaging container, the polymeric liner film (C) faces towards the packaged goods, i.e. it is the layer which is present on the interior of the container.

According to a third aspect of the invention, there is provided a method for preparing a sealed package, wherein the sealed package comprises a product encapsulated within a lined container which is sealed with a polymeric lidding film, the method comprising the steps of:
a) providing a container or sheet (A), wherein the container or sheet comprises a fibrous material;
b) disposing a primer composition onto at least one surface of the container or sheet (A) to form a primer layer (B) on the container or sheet, wherein the primer composition comprises at least one sulfopolyester;
c) disposing a polymeric liner film (C) onto a surface of the primer layer (B) to form a lined sheet or a lined container;
d) where a lined sheet is obtained from step c), forming (preferably thermoforming) a lined container from the lined sheet;
e) placing a product within the lined fibrous container obtained from step c) or d);
f) bonding a polymeric lidding film to the lined fibrous container with product therein obtained from step e) in order to obtain a sealed package.

Thus, the lined fibrous container is sealed and closed by the polymeric lidding film.

According to a fourth aspect of the invention, there is provided a sealed package comprising a product encapsulated within a lined container which is sealed with a polymeric lidding film, wherein the lined container comprises a container (A), a primer layer (B) disposed on at least one surface of the container, and a polymeric liner film (C) disposed on the primer layer, wherein the container (A) comprises a fibrous material and wherein primer layer (B) is derived from a primer composition comprising at least one sulfopolyester.

The sealed package of the fourth aspect may be obtained from the method of the third aspect of the invention.

Preferably, the product encapsulated within the sealed package comprises a foodstuff, more preferably is ovenable, and most preferably is a ready-meal. Preferred ovenable foodstuffs may be cooked and/or heated in a conventional oven and/or a microwave oven.

It will be appreciated that the discussion and preferences for the first aspect of the invention are equally applicable to the method of the third aspect of the invention. Similarly, the discussion and preferences for the second aspect of the invention are equally applicable to the fourth aspect of the invention.

Preferably, the sealed package is hermetically sealed.

The polymeric liner film (C) described herein comprises or consists of a polymeric substrate film. The polymeric liner film is a self-supporting film, by which is meant a film capable of independent existence in the absence of a supporting base. The polymeric substrate film is preferably uniaxially or biaxially oriented, more preferably biaxially oriented.

In a preferred embodiment, the polymeric liner film (C) comprises a polymeric substrate film (C₂) and a heat-sealable layer (C₁). Preferably, the heat-sealable layer (C₁) is a coating layer. Accordingly, in this embodiment, the laminate comprises (or consists of) four layers and has an ABC₁C₂-layer structure. In this embodiment, heat-sealable layer (C₁) is disposed on the polymeric substrate film (C₂). Thus, polymeric substrate film (C₂) is in direct contact with heat-sealable layer (C₁); heat-sealable layer (C₁) is in direct contact with both polymeric substrate film (C₂) and primer layer (B); primer layer (B) is in direct contact with heat-sealable layer (C₁) and container or sheet (A); and container or sheet (A) is in direct contact with primer layer (B).

The polymeric substrate film (C₂) described herein is a self-supporting film, which is preferably uniaxially or biaxially oriented, more preferably biaxially oriented.

The polymeric substrate film (C₂) may be formed from any suitable film-forming polymer, such as polyesters, polyamides, polycarbonates and/or addition polymers (such as polyethylene or polypropylene). Preferably, the polymeric substrate film (C₂) comprises, or consists of, a polyester, preferably a linear polyester. The term “polyester” as used herein is a polymer that encompasses both “homopolyesters” and “copolyesters”.

Suitable polyesters of the polymeric substrate film (C₂) include those derived from one or more dicarboxylic acids and from one or more glycols. The description hereinbelow of the polymeric substrate film (C₂), and the polyesters described in respect thereof, is applicable also to the polymeric substrate film (C) in the embodiment where the substrate film (C) does not have said heat-sealable layer (C₁).

Preferably, the dicarboxylic acid component of the polyester of the polymeric substrate film (C₂) comprises at least one aromatic dicarboxylic acid, such as terephthalic acid (TA), isophthalic acid (IPA), phthalic acid, 1,4-, 2,5-, 2,6- or 2,7-naphthalene dicarboxylic acid and/or 2,5-furan dicarboxylic acid (FDCA). Preferably, the aromatic dicarboxylic acid is selected from IPA, TA and/or 2,6-naphthalene dicarboxylic acid, most preferably from 2,6-naphthalene dicarboxylic acid and/or TA, and preferably from TA. Thus, the polyester of the polymeric substrate film (C₂) is preferably derived from an aromatic dicarboxylic acid, preferably TA and/or 2,6-naphthalene dicarboxylic acid, preferably TA. The polyester of the polymeric substrate film (C₂) may also comprise one or more monomeric units derived from other dicarboxylic acids such as 4,4′-diphenyl dicarboxylic acid, 1,4-cyclohexanedicarboxylic acid (hexahydro-terephthalic acid), 1,10-decane dicarboxylic acid and, in particular, aliphatic dicarboxylic acids including those of the general formula CₙH₂ₙ(COOH)₂ wherein n is 2 to 8 (such as succinic acid, glutaric acid, sebacic acid, adipic acid, azelaic acid, suberic acid or pimelic acid, preferably sebacic acid, adipic acid and azelaic acid, and more preferably azelaic acid). The term “dicarboxylic acids” as used herein includes acid equivalents of dicarboxylic acids having two functional carboxyl groups which perform substantially like dicarboxylic acids in reaction with glycols and diols in forming polyesters, including esters and ester-forming derivatives, such as acid halides and anhydrides.

In one preferred embodiment, the dicarboxylic acid fraction of the polyester of the polymeric substrate film (C₂) is derived from only one dicarboxylic acid, more preferably an aromatic dicarboxylic acid, more preferably TA or 2,6-naphthalene dicarboxylic acid, and most preferably TA.

In an alternative embodiment, the dicarboxylic acid fraction of the polyester of the polymeric substrate film (C₂) is derived from a first aromatic dicarboxylic acid (preferably TA or 2,6-naphthalene dicarboxylic acid, preferably TA) and a second dicarboxylic acid. The second dicarboxylic acid may be any suitable dicarboxylic acid. Preferably, the second dicarboxylic acid is selected from an aliphatic dicarboxylic acid, such as succinic acid, glutaric acid, sebacic acid, adipic acid, azelaic acid, suberic acid or pimelic acid, preferably sebacic acid, adipic acid and azelaic acid, and more preferably azelaic acid. Alternatively, the second dicarboxylic acid may be selected from a second aromatic dicarboxylic acid, such as isophthalic acid.

The glycol component of the polyester of the polymeric substrate film (C₂) preferably consists of at least one aliphatic glycol and/or cycloaliphatic glycol. Suitable glycols are low molecular weight glycols (i.e. having a molecular weight below about 250) including acyclic, alicyclic and aromatic dihydroxy compounds. Preferred compounds are diols with 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Preferred compounds are ethylene glycol (EG), 1,3-propanediol, 1,4-butanediol, neopentyl glycol and/or 1,4-cyclohexane dimethanol (CHDM), most preferably ethylene glycol. Equivalent ester-forming derivatives of diols may be used in place of the diol. The term “low molecular weight diols” as used herein encompasses such equivalent ester-forming derivatives; provided that the molecular weight requirement pertains to the diol and not to its derivatives. Preferred polyesters of the polymeric substrate film (C₂) are derived from only one glycol, more preferably an aliphatic glycol, most preferably ethylene glycol.

Preferably, the polyester of the polymeric substrate film (C₂) is derived from one aromatic dicarboxylic acid and one aliphatic glycol. Alternatively, the polyester of the polymeric substrate film (C₂) is derived from an aromatic dicarboxylic acid (preferably TA), a second dicarboxylic acid (preferably isophthalic acid or an aliphatic dicarboxylic acid, such as azelaic acid) and an aliphatic glycol.

Preferred polyesters of the polymeric substrate film (C₂) are: polyethylene terephthalate (PET); polyethylene 2,6-naphthalate (PEN); copolyesters comprising (or consisting of) monomeric units derived from TA, at least one aliphatic dicarboxylic acid and at least one diol; polylactic acid (PLA); polyethylene furanoate (PEF); and/or polyhydroxybutyrate (PHB). Particularly preferred polyesters are PEF, PET and/or PEN, more preferably PET and/or PEN, most preferably PET.

In a preferred embodiment, the polymeric substrate film (C₂) is thermoformable.

In other words, the film preferably:
(i) reversibly softens at temperatures above the glass transition temperature (Tg) thereof and, if the material exhibits a crystalline melting temperature (Tm), below the crystalline melting temperature, at which temperatures the material assumes a rubbery solid state such that it is deformable by an external force; and
(ii) once the film has been cooled below its glass transition point, retain the deformation which was introduced into the film while at a temperature above the glass transition point.

Suitable thermoformable films are commercially available and the skilled person is well aware of their methods of manufacture and the characteristics thereof.

Thermoformability is indicated by the stress-strain curve above the glass transition temperature of the material (see, for instance, “Thermoforming” by James L. Throne (Pub. Karl Henser Verlag, Munich 1987; ISBN 3-446-14699-7). A thermoformable polymeric film is characterised by a relatively low force required to stretch a film above its Tg and a relatively high extent of stretching, when compared with a standard polymeric film. Thermoformability requires that the deformed film retains the deformed shape, once cooled and an important characteristic of a thermoformable film is therefore the relaxation of induced stress at the processing temperature after stretching the film to the desired strain. The characteristic is usually expressed as a percentage of stress retained after a defined time period (in seconds), or as the time required to relax stress by a defined percentage, and in a thermoformable film the values of these parameters should be as low as possible, as is well known in the art (see for instance “Viscoelastic Properties of Polymers”; John D. Ferry, page 8 et seq., 3^{rd} Ed, Wiley, NY; ISBN 0-471-04894-1; and “Mechanical Properties of Solid Polymers”, I. M. Ward, 2^{nd} Ed., John Wiley)).

A thermoformable film preferably comprises a polyester, preferably a copolyester. Preferably, the polyester has a glass transition temperature (Tg) below about 110° C., more preferably below about 100° C., more preferably in the range from about 30 to about 100° C., more preferably in the range from about 40 to about 90° C.

In Embodiment R1, a thermormable polymeric substrate film comprises, and preferably is, a copolyester film wherein the copolyester is derived from:
(i) one or more diol(s);
(ii) an aromatic dicarboxylic acid; and
(iii) one or more aliphatic dicarboxylic acid(s) of the general formula CₙH₂ₙ(COOH)₂ wherein n is 2 to 10, preferably 4 to 10,
   wherein the aliphatic dicarboxylic acid is present in the copolyester in an amount of from about 1 to about 20 mol %, preferably from about 1 to 10 mol %, preferably from about 3 to about 10 mol %, based on the total amount of dicarboxylic acid components in the copolyester, wherein the copolyester is a random or alternating copolyester. The aromatic dicarboxylic acid is preferably selected from terephthalic acid, isophthalic acid, phthalic acid, 2,5-, 2,6- or 2,7-naphthalenedicarboxylic acid, and is preferably terephthalic acid. The diol is preferably selected from aliphatic and cycloaliphatic glycols, e.g. ethylene glycol, 1,3-propanediol, 1,4-butanediol, neopentyl glycol and 1,4-cyclohexanedimethanol, preferably from aliphatic glycols. Preferably the copolyester contains only one glycol, preferably ethylene glycol. The aliphatic dicarboxylic acid is preferably saturated and preferably selected from succinic acid, glutaric acid, adipic acid, pimelic acid, suberic acid, azelaic acid or sebacic acid. In a preferred embodiment, the aliphatic dicarboxylic acid is selected from succinic acid, adipic acid, azelaic acid and sebacic acid. Preferably the copolyester contains only one aliphatic dicarboxylic acid. Preferably the aliphatic dicarboxylic acid is azelaic acid. Particularly preferred examples of copolyesters are (i) copolyesters of azelaic acid and terephthalic acid with ethylene glycol; (ii) copolyesters of adipic acid and terephthalic acid with ethylene glycol; and (iii) copolyesters of sebacic acid and terephthalic acid with an ethylene glycol. Particularly preferred copolyesters are those of azelaic acid and terephthalic acid with ethylene glycol. The copolyester is a random or alternating copolyester, as opposed to a block copolyester. Preferably, the copolyester is a random copolyester. Reference herein to a random copolyester means a copolyester wherein the different ester monomeric units, i.e. the [aromatic dicarboxylic acid-diol] units and the [aliphatic dicarboxylic acid-diol] units are situated randomly in the chain. Reference herein to an alternating copolyester means a copolyester wherein there is an ordered alternation of the monomeric ester units.

In Embodiment R2, a thermormable polymeric substrate film comprises, and preferably is, a copolyester film wherein the copolyester is derived from one or more diol(s) as described for Embodiment R1, and a dicarboxylic acid component comprising first and second aromatic dicarboxylic acids as described for Embodiment R1, wherein the first dicarboxylic acid is present in amounts from 80 to 96 mol % of the total di-acid component and is selected from terephthalic acid, and wherein the second aromatic dicarboxylic acid is present in amounts from about 4 to about 20 mol % of the total di-acid component and is preferably selected from isophthalic acid.

In Embodiment R3, a thermormable polymeric substrate film comprises, and preferably is, a copolyester film wherein the copolyester is derived from a diol component comprising a first and second diol, wherein the first diol is an aliphatic glycol as described for Embodiment R1 (preferably ethylene glycol) present in an amount of from about 70 to about 96 mol % and the second diol is a cycloaliphatic glycol (preferably 1,4-cyclohexanedimethanol) present in an amount of from about 4 to about 30 mol %, and wherein the dicarboxylic acid component of the copolyester is as described for Embodiment R1, and which preferably comprises or consists of terephthalic acid.

In Embodiment R4, a thermormable polymeric substrate film is a polyester film in which the polyester comprises, and preferably is, a blend of Component I and Component II, preferably wherein Component I is present in an amount of no more than 50% and preferably greater than 40% by weight of the layer, and Component II is present in an amount of at least 50% and preferably no more than 60% by weight of the layer, wherein:
(i) Component I is a copolyester derived from one or more diol(s) as described for Embodiment R1, and a dicarboxylic acid component comprising first and second aromatic dicarboxylic acids, as described for Embodiment R1, wherein the first dicarboxylic acid is present in amounts from 80 to 96 mol % of the total di-acid component and is selected from terephthalic acid and the second aromatic dicarboxylic acid is present in amounts from about 4 to about 20 mol % of the total di-acid component, and
(ii) Component II is a polyester derived from 1,4-butylene diol and one or more (preferably one) dicarboxylic acid(s) as described for Embodiment R1, and preferably one or more (preferably one) aromatic dicarboxylic acid(s), preferably terephthalic acid.

Thermoformability of the film can be further improved by incorporating a plasticizer. Suitable plasticizers include aromatic dicarboxylic acid esters such as dimethyl phthalate, diethyl phthalate, di-n-butyl phthalate, di-n-hexyl phthalate, di-n-heptyl phthalate, di-2-ethylhexyl phthalate, di-n-octyl phthalate, di-n-nonyl phthalate, diethyl isophthalate, di-n-butyl isophthalate, di-2-ethylhexyl isophthalate, diethyl terephthalate, di-n-butyl terephthalate, di-2-ethylhexyl terephthalate, etc.; phosphoric acid esters such as triethyl phosphate, tri-n-butyl phosphate, trioctyl phosphate, cresyl phosphate, etc.; sebacic acid esters such as dimethyl sebacate, diethyl sebacate, di-n-butyl sebacate, diamyl sebacate, etc.; adipic acid esters such as hexyl adipate, etc.; esters such as butyl phthalyl butyl glycolate, tributyl citrate, tetrahydrofurfuryl oleate, methyl acetyl ricinoleate, etc.; and polyethylene glycol, etc. In one embodiment, the plasticizer is selected from aromatic dicarboxylic acid esters (particularly phthalic acid esters). The melting point at atmospheric pressure of the plasticizer is preferably at least 300° C. or higher, more preferably at least 350° C. The content of the plasticizer in the layer is preferably 0.01 to 5 wt %, more preferably 0.05 to 2 wt % based on the weight of the polymeric material of the layer.

The film-forming polymer is the major component of the polymeric substrate film (C₂). The film-forming polyester makes up at least 50% by weight of the total weight, preferably at least 65%, preferably at least 80%, preferably at least 85%, preferably at least 90%, preferably at least 95%, more typically at least 98%, more typically at least 99% by weight of the total weight of the film layer which it forms.

Preferably, the intrinsic viscosity of the polymer of the polymeric substrate film (C₂) is from about 0.5 dL/g to about 0.8 dL/g, preferably from about 0.55 dL/g to about 0.7 dL/g, and most preferably from about 0.55 dL/g to about 0.65 dL/g.

The polymeric substrate film (C₂) is preferably a monolayer film.

The heat-sealable layer (C₁) may be formed from any polymeric material suitable as a heat-sealable coating on a polymeric base film. Preferred heat-sealable polymeric materials are PET-based copolyesters, preferably amorphous copolyesters. The general description of the diol(s) and dicarboxylic acid(s) in the polyester of polymeric substrate film (C₂) are generally applicable also to the polymers of the heat-sealable layer (C₁). Preferably, the copolyester is derived from one or more diol(s) and two or more dicarboxylic acid(s). Preferably, the copolyester is derived from an aliphatic glycol (preferably ethylene glycol), a first dicarboxylic acid (preferably terephthalic acid) and a second dicarboxylic acid (preferably isophthalic acid or azelaic acid).

In one preferred embodiment, the copolyester of the heat-sealable polymeric material is derived from an aliphatic glycol (preferably ethylene glycol), a first aromatic dicarboxylic acid (preferably TA) and a second aromatic dicarboxylic acid (preferably isophthalic acid). In this copolyester, the preferred molar ratio of the first dicarboxylic acid (preferably TA) to the second dicarboxylic acid (preferably isophthalic acid) is in the range of from 50:50 to 90:10, preferably in the range from 65:35 to 85:15. In a preferred embodiment, this copolyester is a copolyester of ethylene glycol with about 82 mole % terephthalate and about 18 mole % isophthalate.

In a further preferred embodiment, the copolyester of the heat-sealable polymeric material is derived from an aliphatic diol and a cycloaliphatic diol with one or more, preferably one, dicarboxylic acid(s), preferably an aromatic dicarboxylic acid. Examples include copolyesters of terephthalic acid with an aliphatic diol and a cycloaliphatic diol, especially ethylene glycol and 1,4-cyclohexanedimethanol. The preferred molar ratios of the cycloaliphatic diol to the aliphatic diol are in the range from 10:90 to 60:40, preferably in the range from 20:80 to 40:60, and more preferably from 30:70 to 35:65. In an alternative embodiment, the polymer may comprise butane diol in place of ethylene glycol.

In a further preferred embodiment, which is particularly preferred, the copolyester of the heat-sealable polymeric material is a copolyester in which the acid components are selected from one or more (preferably one) aromatic dicarboxylic acid(s) and one or more (preferably one) aliphatic dicarboxylic acid(s) (preferably a saturated aliphatic dicarboxylic acid of the general formula CₙH₂ₙ(COOH)₂ wherein n is 2 to 8). A preferred aromatic dicarboxylic acid is terephthalic acid. Preferred aliphatic dicarboxylic acids are selected from sebacic acid, adipic acid and azelaic acid. The concentration of the aromatic dicarboxylic acid present in the copolyester is preferably in the range from 45 to 80, more preferably in the range 45 to 75, more preferably 50 to 70, and particularly 55 to 65 mole % based on the dicarboxylic acid components of the copolyester. The concentration of the aliphatic dicarboxylic acid present in the copolyester is preferably in the range from 20 to 55, preferably in the range of 25 to 55, more preferably 30 to 50, and particularly 35 to 45 mole % based on the dicarboxylic acid components of the copolyester. Particularly preferred examples of such copolyesters are (i) copolyesters of azelaic acid and terephthalic acid with an aliphatic glycol, preferably ethylene glycol; (ii) copolyesters of adipic acid and terephthalic acid with an aliphatic glycol, preferably ethylene glycol; and (iii) copolyesters of sebacic acid and terephthalic acid with an aliphatic glycol, preferably butylene glycol. Preferred polymers include a copolyester of sebacic acid/terephthalic acid/butylene glycol (preferably having the components in the relative molar ratios of 45-55/55-45/100, more preferably 50/50/100) having a glass transition point (Tg) of −40° C. and a melting point (Tm) of 117° C.), and a copolyester of azelaic acid/terephthalic acid/ethylene glycol (preferably having the components in the relative molar ratios of 40-50/60-50/100, more preferably 45/55/100) having a Tg of −15° C. and a Tm of 150° C.

The amount and/or ratio of comonomer used in the copolyester of the heat-sealable layer may be adjusted to optimise the strength of the seal when the polymeric liner film is bonded to the primed fibrous material. Further factors, such as the initiation temperature, the amount of any filler and the flow characteristics of the heat-seal layer may also be adjusted in order to optimise the bond strength.

The heat-sealable polymeric material is the major component of the heat-sealable layer (C₁), comprising at least 50%, preferably at least 65%, preferably at least 80%, preferably at least 90%, and preferably at least 95% by weight of the total weight of the heat-sealable layer (C₁). The heat-sealable layer (C₁) may consist essentially of (or consist of) the heat-sealable polymeric material. One or more tackifiers, antifog agents, and/or other additives known to those skilled in the art may make up the balance of the layer. For instance, ingredients such as inorganic slip agents (e.g. silica, titanium dioxide) and organic wax (chemical slip) may be present in the heat-sealable layer (C₁) in minor amounts, as is conventional in the art, in order to improve handling of the polymer liner film.

Preferably, each of said polymeric substrate film (C₂) and said heat-sealable layer (C₁) is made of a single type of polyester in order to increase the recyclability of the polymer liner film.

The bond between heat-sealable layer (C₁) and primer layer (B) is achieved by heating (preferably by the heat applied during a thermoforming step), in order to soften the polymeric material of the heat-sealable layer (C₁) without melting any of the other layers in the polymeric liner film (such as polymeric substrate film (C₂) or primer layer (B)), and applying pressure (preferably by the pressure applied during a thermoforming step). Thus, the polymeric material of the heat-sealable layer (C₁) should begin to soften at a temperature such that the bond can be formed at a temperature which is less than the melting temperature of the polymeric substrate film (C₂) and primer layer (B).

Thus, it is preferred that the heat and pressure applied during the thermoforming step is such that the polymeric liner film (C) is softened to a sufficient extent that it adheres onto the surface of the primer layer (B), thereby effecting a bond therebetween. As described hereinabove, steps c) and d) of the methods described herein may be performed simultaneously.

In the step of bonding the polymeric liner film to the primed fibrous container or sheet, the polymeric material of the heat-sealable layer (C₁) softens to a sufficient extent that its viscosity becomes low enough to allow adequate wetting for it to adhere to the primer layer (B) (which is disposed on the sheet or container (A)) to which it is being bonded. Preferably, the polymeric material of the heat-sealable layer (C₁) should begin to soften at a temperature such that the bond is formed at a temperature which is from about 5° C. to about 130° C. below (preferably from about 5° C. to about 100° C. below, preferably from about 5° C. to about 50° C., preferably from about 5 to about 30° C. below, and preferably at a temperature at least about 10° C. below), the melting temperature of the polymeric substrate film (C₂) and the primer layer (B).

Preferably, the polymeric liner film (C) has a total film thickness (i.e. including the heat-sealable layer (C₁)) of at least about 20 μm, preferably at least about 21 μm, preferably at least about 23 μm, preferably at least about 24 μm, preferably at least about 28 μm. Preferably, the polymeric liner film (C) has a total film thickness of no more than about 160 μm, preferably no more than about 110 μm, preferably no more than about 70 μm, preferably no more than about 65 μm, preferably no more than about 60 μm. Accordingly, the polymeric liner film (C) preferably has a total film thickness of from about 20 μm to about 160 μm, preferably from about 21 to about 110 μm, preferably from about 23 to about 70 μm, preferably from about 24 to about 65 μm, preferably from about 28 to about 60 μm.

Preferably, the polymeric substrate film (C₂) (i.e. the polymeric substrate film without the heat-sealable layer (C₂)) has a film thickness of at least about 15 μm, preferably at least about 16 μm, preferably at least about 18 μm, preferably at least about 19 μm, preferably at least about 23 μm. In some embodiments, the polymeric substrate film (C₂) has a film thickness of no more than 150 μm, preferably no more than about 100 μm, preferably no more than about 60 μm, preferably no more than about 55 μm, preferably no more than about 50 μm. Accordingly, the polymeric substrate film (C₂) preferably has a film thickness of from about 15 to about 150 μm, preferably from about 16 to about 100 μm, preferably from about 18 to about 60 μm, preferably from about 19 to about 55 μm, preferably from about 23 to about 50 μm.

When a polymeric liner film is thermoformed, the polymeric material may shrink which may have the effect of lifting the liner film from the container, thereby weakening or breaking the seal between the liner film and the primed surface of the container. Thus, preferably, the polymeric liner film preferably exhibits a low shrinkage, preferably less than 3.5%, preferably less than 3%, preferably less than 2%, preferably less than 1.5%, and preferably less than 1.0% when heated in air in an oven at 150° C. for 30 minutes, particularly in the machine (longitudinal dimension) of the film. Preferably, such low shrinkage values are exhibited in both dimensions of the film (i.e. the longitudinal and transverse dimensions). Preferably, such low shrinkage values are exhibited before the polymeric liner film has undergone forming, such as thermoforming. Methods of controlling shrinkage in the polymeric liner film by varying process parameters during the stretching and heat-setting steps of film manufacture are well-known to the skilled person.

Preferred polymeric liner films are substantially transparent to visible light and thus are substantially free of opacifying agents such as pigments, dyes or voiding agents.

Optionally a barrier layer may be present on the polymeric liner film. Conventional barrier layers include PVDC, EVOH and PVOH. PVDC layers are particularly suitable for providing a barrier to both gas and water vapour; EVOH and PVOH layers are particularly suitable for providing a barrier to gas. Suitable layers are known in the art and are disclosed, for instance, in U.S. Pat. No. 5,328,724 (EVOH), U.S. Pat. No. 5,151,331 (PVDC), U.S. Pat. No. 3,959,526 (PVDC), U.S. Pat. No. 6,004,660 (PVDC and PVOH). The barrier payer is suitably present in the polymeric liner film (C) between the polymeric substrate film (C₂) and the heat-sealable layer (C₁). Typically, however, an additional barrier layer is not present.

Formation of the polyesters described herein is conveniently effected in a known manner by condensation or ester-interchange, generally at temperatures up to about 300° C., preferably up to about 295° C. In a preferred embodiment, solid state polymerisation may be used to increase the intrinsic viscosity of the (optionally crystallizable) polymers to the desired value, using conventional techniques well-known in the art, for instance using a fluidized bed such as a nitrogen fluidized bed or a vacuum fluidized bed using a rotary vacuum drier.

The films described herein (e.g. the polymeric liner film (C), the polymeric substrate film (C₂) and/or the heat-sealable layer (C₁)) may be produced using conventional techniques in the art. In general terms the process comprises the steps of extruding a layer of molten polymer, quenching the extrudate and orienting the quenched extrudate in at least one direction.

Extrusion is generally carried out at temperatures up to about 300° C., preferably from about 250° C. to about 300° C., followed by quenching the extrudate and orienting the quenched extrudate. Preferred polymeric films are obtained from polymers extruded at a temperature of from about 270° C. to about 300° C., preferably from about 280° C. to about 300° C.

Orientation of the quenched extrudate may be effected by any process known in the art for producing an oriented film, for example a tubular or flat film process. Orientation is well known to those skilled in the art and is described, for example, in WO-2018/206928-A1 on page 14, lines 12 to 32, which passage is incorporated herein by reference. The stretched film may be heat-set to stabilise the dimensions of the film. Heat-setting is well known to those skilled in the art and is described, for example, in WO-2018/206928-A1 on page 14, lines 12 to 32, which passage is incorporated herein by reference. The orientated film may further stabilised by a relaxation stage, which may be performed either in-line or off-line. Film relaxation is well known to those skilled in the art and is described, for example, in WO-2018/206928-A1 on page 15, lines 16 to 33, which passage is incorporated herein by reference.

The heat-sealable layer (C₁) may be co-extruded with the polymeric substrate film (C₂). Preferably, however, the heat-sealable layer (C₁) is a coating layer. Thus, preferably, the heat-sealable layer (C₁) is derived from a coating composition which is coated on the polymeric substrate film (C₂). Thus, the heat-sealable layer is preferably disposed by a coating technique, rather than by lamination or co-extrusion. Any suitable coating technique may be used, for instance roll coating, and including gravure roll coating and reverse roll coating, or by any spray-coating technique conventional in the art. The heat-sealable coating layer (B) composition is then dried and/or heated.

The polymeric liner films used herein may further comprise other additives conventionally employed in the manufacture of polymeric films. Thus, additives such as cross-linking agents, lubricants, antioxidants, radical scavengers, thermal stabilisers, flame retardants and inhibitors, anti-blocking agents, surface active agents, slip aids, gloss improvers, pro-degradents, viscosity modifiers and/or dispersion stabilisers may be incorporated as appropriate. Such components may be introduced into the polymer in a conventional manner. For example, the components may by mixed with the monomeric reactants from which the polymer is derived, or the components may be mixed with the polymer by tumble or dry-blending, or the components may be introduced by compounding in an extruder, followed by cooling and, usually, comminution into granules or chips. The well-known technique of masterbatching may also be employed to incorporate other components into the polymeric film.

Surprisingly, the applicant has found that certain primer layers may be used to provide improved bond strength between polymeric liner films and fibrous containers. Such primers can be applied directly to the surface of fibrous containers or sheets (such as paperboard and/or carton board) and bond well thereto. Such primer layers also bond well to subsequently applied polymeric film liners (such as polyester film liners).

The primer layer is derived from a primer composition. The primer layer is coated onto the sheet and/or container. Coating may be effected using any suitable coating technique, as discussed herein in relation to primer layer and the heat-sealable coating layer.

Preferably, the primer composition is an aqueous composition. Preferably, the primer composition is an aqueous composition comprising at least one sulfopolyester, wherein the at least one sulfopolyester is water-dispersible.

Without wishing to be bound by theory the applicant believes that the primer material described herein absorbs sufficiently into the fibrous surface to adhere well thereto due to the compatibility of the primer material with the fibrous material and the hydrophobic fibres thereof, whilst the primer material remains sufficiently available as a film-forming layer at the surface to provide improved adhesion when a polymeric liner film is disposed thereon. The primer layer provides particularly improved adhesion when heat-sealable layer (C₁) of the polymeric liner film is subsequently disposed thereon. This allows the polymeric liner film to be more easily bonded to the fibrous sheets and/or containers to produce a laminate with improved delamination resistance. The primer layer also allows for easier removal of the polymeric liner film from the fibrous container after use, which therefore increases the ease of recycling.

Preferably, the at least one sulfopolyester is water-dispersible and therefore, if necessary, any sulfopolyester absorbed within the fibrous material may be readily removed during recycling.

Surprisingly, it has been found that applying primer layer (B) to a fibrous sheet or container (A) improves the bond adhesion between the fibrous sheet or container (A) and the polymeric film liner (C) to a level similar or comparable to that measured between the polymeric film liner and an APET container.

The primer composition comprises at least one sulfopolyester. Preferably, the primer composition is applied to the surface to be primed as an aqueous dispersion of at least one sulfopolyester.

The term “sulfopolyester” as used herein is a polyester that contains residues of a sulfomonomer.

Sulfopolyester(s) denotes polyester(s) containing ionic sulfonate (SO₃⁻) group(s), usefully prepared using sulfonated dicarboxylic acid(s) as at least one of the monomers within the polyester. Preferably, the dicarboxylic acid of the sulfonated dicarboxylic acid is selected from terephthalic acid, isophthalic acid, phthalic acid, 2,5-, 2,6- and/or 2,7-naphthalenedicarboxylic acid. Preferably, the dicarboxylic acid of the sulfonated dicarboxylic acid is isophthalic acid. Preferably, the sulfonated dicarboxylic acid is 5-sodium sulfo-isophthalic acid (5-SSIPA or SIP) and/or or dimethyl 5-sodium sulfo-isophthalate. Sulfopolyesters are typically linear and amorphous and, due to the ionic sulfonate groups, can be dispersed in water without using surfactants or amines and so are often supplied dispersed in water.

Preferred sulfopolyester(s) are derived from an acid component comprising: a) dicarboxylic acid compounds, derivatives of dicarboxylic acid compounds, or combinations thereof; and/or b) sulfomonomer component(s) having at least one ionic sulfonate group covalently bonded directly or indirectly to an aromatic or cycloaliphatic ring, the ionic sulfonate group being represented by the moiety—SO₃⁻. It will be appreciated that the sulfopolyester(s) also contain residues of one or more diol(s).

Preferred sulfopolyesters may be derived from isophthalic acid, 5-sodium sulfo-isophthalic acid (5-SSIPA), 1,4-cyclohexanedimethanol (CHDM) and diethylene glycol (DEG). Preferably, the sulfopolyesters have a number-average molecular weight Mₙ of between about 5 and 15 kDA, a weight-average molecular weight (M_{w}) of between about 20 and 30 kDA and a polydispersity index (M_{w}/Mₙ) of about 2. Preferably, the sulfopolyester has a glass transition temperature (T_{g}) of between about 0° C. and about 65° C.

The composition from which the primer layer (B) is derived suitably comprises at least one sulfopolyester and a coating vehicle. The coating vehicle is preferably an aqueous coating vehicle, and is preferably water.

The composition from which the primer layer (B) is derived may further comprise at least one crosslinking agent. The crosslinking agent may function to crosslink the composition to improve adhesion to the fibrous container or sheet and to the subsequently applied polymeric liner. The crosslinking agent should also be capable of internal crosslinking within the primer composition. Thus, the primer layer (B) may comprise at least one cross-linked sulfopolyester.

Suitable crosslinking agents may be water-soluble crosslinking agents or water-insoluble crosslinking agents. Preferably, the crosslinking agent is a water-soluble crosslinking agent. Preferably, the crosslinking agent is an organic crosslinking agent. Preferably, the organic crosslinking agent is a water-soluble crosslinking agent.

Suitable crosslinking agents include melamines, isocyanates, oxazolines, aziridines, carbodiimides, epoxy resins, silanes and zirconium based crosslinking agents. The crosslinking agent is preferably a melamine crosslinking agent.

As used herein, the term “melamine crosslinking agent” refers to one or more derivatives of melamine (1,3,5-triazine-2,4,6-triamine) in which the amino groups are functionalised with reactive functional groups which are capable of undergoing crosslinking reactions through the action of heat and/or an acidic catalyst.

A preferred melamine crosslinking agent comprises one or more monomeric derivatives of melamine in which some or all of the amine groups are functionalised with alkoxymethyl or hydroxymethyl groups and/or oligomers (for example dimers, trimers and tetramers) derived from such monomeric melamine derivatives. These derivatives of melamine may suitably be obtained by reaction of melamine with formaldehyde, followed by alkylation of some or all of the resulting methylol groups with an alcohol. In general, the melamine crosslinking agent (i) will contain a statistical mixture of different melamine derivatives, as determined by the formaldehyde and alkylation stoichiometries.

Preferred melamine crosslinking agents have a formaldehyde stoichiometry (defined as the number of formaldehyde equivalents per molecule of melamine) of at least 3. For example, the formaldehyde stoichiometry may be in the range of from 3 to 4.5, preferably 3.3 to 4.3, preferably 3.3 to 4.1, indicating a melamine crosslinking agent with a relatively high imine content. Alternatively, the formaldehyde stoichiometry may be greater than 4.5, preferably at least 5, preferably at least 5.5, indicating a melamine crosslinking agent with a relatively low imine content. Further preferred melamine crosslinking agents have a formaldehyde stoichiometry of at least 5.5, for example at least 5.8 or at least 5.9.

Further preferred melamine crosslinking agents have an alkylation stoichiometry (defined as the number of alkylated methylol groups per molecule of melamine) of at least 1. For example the alkylation stoichiometry may be at least 2, at least 3, at least 4 or at least 5. It will be understood that the alkylation stoichiometry may not be greater than the formaldehyde stoichiometry.

Examples of preferred melamine crosslinking agents include those having a formaldehyde stoichiometry of from 3.0 to 4.5, preferably 3.3 to 4.3, preferably 3.3 to 4.1 and an alkylation stoichiometry of from 1.0 to 3.2, preferably 1.5 to 3.0.

Further examples of preferred melamine crosslinking agents include those having a formaldehyde stoichiometry of greater than 4.5, preferably at least 5, preferably at least 5.5 and an alkylation stoichiometry of from 3.5 to 5.9, preferably 4.0 to 5.9, preferably 4.5 to 5.9.

The alkylated methylol groups are preferably selected from C₁ to C₄ alkoxymethyl groups, more preferably from methoxymethyl groups or n-butoxymethyl groups, and most preferably the alkylated methylol groups are methoxymethyl groups. Thus, the alcohol used to alkylate the methylol groups is preferably selected from C₁ to C₄ alcohols, more preferably methanol or n-butanol, and most preferably methanol.

A particularly preferred constituent of the melamine crosslinking agent is hexamethoxymethylmelamine, i.e. melamine in which each amine group is functionalised by two methoxymethyl groups.

Suitable melamine crosslinking agents for use in the present invention may be selected from those available from Cytec under the tradename Cymel®, such as Cymel® XW 3106 and Cymel® 350, preferably Cymel® XW 350. Cymel® XW 3106 is a water insoluble, specifically alkylated high solids melamine resin. Cymel® 350 is a water soluble, highly methylated monomer melamine resin.

Preferably, the composition from which the primer layer (B) is derived comprises at least about 25% by weight of the sulfopolyester based on the total weight of the sulfopolyester and the coating vehicle. Preferably, the composition from which the primer layer (B) is derived comprises no more than about 35% by weight of the sulfopolyester based on the total weight of the sulfopolyester and the coating vehicle.

Preferably, the composition from which the primer layer (B) is derived comprises at least about 65% by weight of the coating vehicle based on the total weight of the sulfopolyester and the coating vehicle. Preferably, the composition from which the primer layer (B) is derived comprises no more than about 75% by weight of the sulfopolyester based on the total weight of the sulfopolyester and the coating vehicle.

Thus, preferably the composition from which the primer layer (B) is derived comprises the sulfopolyester in an amount of about 25% to about 35% by weight based on the total weight of the sulfopolyester and the coating vehicle and preferably comprises the coating vehicle in an amount of about 65% to about 75% by weight percent based on the total weight of the sulfopolyester and the aqueous coating vehicle.

The primer composition preferably comprises the coating vehicle in an amount such that the composition has a solids content of 1 to 15%, preferably 3% to 12%, preferably 4 to 10%, preferably 5 to 8%, preferably 6% to 7% by weight relative to the total weight of the composition.

Particularly preferred sulfopolyester(s) are those which have one or more of the following properties: hardness, high crystallinity, low sensitivity to moisture (optionally due to the presence of a low amount of SIP groups) and/or compatibility with components of the optional heat-sealable layer of the liner film.

As used herein SIP groups denotes functional groups present on a sulfopolyester polymer chain that are, or are derived from, 5-sodium sulfo-isophthalic acid (5-SSIPA or SIP) monomer.

In one embodiment, the amount of sulfomonomer (for example SIP) used to make the sulfopolyester, or the quantity of sulfomonomer residues present in the sulfopolyester, may be from about 1 mol % to about 20 mol %, preferably from about 1 mol % to about 15 mol %, preferably from about 2 mol % to about mol %, preferably from about 3 mol % to about 8 mol %, wherein the mol % is based on the total moles of all monomer residues of the sulfopolyester being 100%.

In another embodiment, the amount of sulfomonomer (for example SIP) used to make the sulfopolyester, or the quantity of sulfomonomer residues present in the sulfopolyester, may be from about 3 mol % to about 20 mol %, preferably from about 5 mol % to about 15 mol %, preferably from about 7 mol % to about 12 mol %, preferably from about 8 mol % to about 10 mol %, where the mol % is based on the total moles of the acid component of the sulfopolyester being 100%.

The sheet or container (A) comprises a fibrous material. The fibrous material is preferably nonwoven.

The fibrous material may comprise any suitable, low-cost fibres known in the art. The fibres may comprise organic fibres, inorganic fibres and/or any suitable mixtures thereof. Fibres may be man-made, synthetic, come from natural sources, recycled and/or comprise any suitable mixtures thereof. The fibres may be further treated (e.g. chemically and/or mechanically).

In one embodiment, the fibrous material may comprise inorganic fibres (e.g. glass fibres). However, these fibres are not preferred as they may not be suitable to prepare fibrous containers for use with foodstuffs.

Particularly preferred fibrous materials comprise organic fibres (for example, pulp-based materials) well known to prepare paper products.

Preferred organic fibres may be fibres of synthetic organic polymer and/or natural fibres, preferably natural fibres.

Suitable synthetic organic polymer fibres include fibres of acrylic polymer (e.g. PVA), polyamide (e.g. nylon), polyester, polysulfone, suitable copolymers thereof and/or suitable mixtures thereof. However, obtaining new synthetic organic fibres is generally much more expensive than obtaining new natural organic fibres, and therefore the use of synthetic organic polymer fibres is not preferred.

Suitable natural organic fibres include lignocellulose fibres, preferably lignin, hemicellulose and/or cellulose fibres, most preferably cellulose fibres (e.g. reconstituted cellulose fibres, such as rayon fibres). Natural fibres are typically obtained new from a natural source. The natural fibres may be extracted and/or modified (e.g. treated biologically, chemically, enzymatically, and/or mechanically) and/or further treated (e.g. coated) before use in the fibrous materials, sheets and/or containers as described herein.

Preferably, the fibrous material exhibits water resistance. Thus, the fibres may be coated such that the fibrous material exhibits water resistance.

Lignocellulose fibres are naturally hydrophobic and need not be further coated to provide water resistance to the fibre which is advantageous for preparing fibrous containers intended to pack products which contain water (such as foodstuffs). Thus, preferably the fibrous material comprises lignocellulose fibres.

Preferred fibrous materials suitable for preparing the sheets and/or containers (A) described herein comprise the fibres described herein in an amount of at least about 50% by weight, preferably at least about 60% by weight, preferably at least about 70% by weight, preferably at least about 80% by weight, for example at least about 90% by weight based on the total weight of the sheet or container.

The fibrous material may be obtained from a new virgin, source, preferably in a sustainable manner and/or from recycled sources. Suitable sources of fibres may include plants, for example bagasse (treated sugar cane residue), bamboo, cotton (e.g. cotton linters), crop waste, flax, grasses, hemp, jute, kenaf, straw and/or wood (e.g. wood pulp); animals, for example feathers, fur, hair and/or wool; recycled fibrous materials, for example recycled fabric (e.g. from clothing); recycled synthetic polymers, secondary fibres, shoddy, shredded rags, waste fibres and/or waste paper; and/or any suitable mixtures thereof. Particularly preferred fibres are those obtained and/or obtainable from straw, wood pulp and/or waste paper.

The fibrous material may be obtained (in whole or in part) from a recycled source, preferably from organic fibres, more preferably from natural organic fibres. Recycled fibres may be present in an amount of at least about 10% by weight, preferably at least about 20% by weight, preferably at least about 30% by weight, preferably at least about 40% by weight, preferably at least about 50 by weight % based on the total weight of the fibrous material, fibrous sheet or fibrous container of which they form a part. Fibrous containers made from such recycled fibrous materials are themselves readily recycled, cheap to produce and/or have low impact on the environment.

The fibrous containers may comprise one layer (for example, single ply paperboard), multiple layers (for example, multi-ply) and/or other laminate structures (for example, corrugated board).

Fibrous sheets and fibrous containers as described herein may be prepared from any of the suitable fibres and/or fibrous materials described herein, for example by using processes for making paper which are well known to those skilled in the art.

Suitable fibrous materials and/or fibrous sheets for use herein comprise (or consist of) boxboard, card, cardboard, cartonboard, chipboard, container board, corrugated fibre board, Kraft board, laminated board, paper, paperboard, pulp-based materials, solid bleached board (SSB), solid unbleached board (SUB) and/or any suitable mixtures thereof. Preferably, the suitable fibrous materials and/or fibrous sheets comprise (or consist of) paperboard and/or cartonboard, preferably paperboard.

The fibrous sheets and/or containers (preferably comprising paperboard and/or cartonboard) may be coated with inorganic fillers to improve the appearance of, and to add weight to, the surface of the fibrous material. Such fillers may comprise china clay, kaolin and the like.

Fibrous containers comprising (or consisting of) paperboard and/or cartonboard trays are particularly preferred, paperboard trays being more preferred.

Cardboard is a generic term for heavy-duty pulp-based paper products having greater thickness and superior durability than conventional paper; such as foldability, rigidity and impact resistance. Container board has a thickness of at least 0.25 mm.

Corrugated fibreboard, also known as corrugated board or corrugated cardboard, comprises a fluted corrugated sheet as a core layer and, as outer layer(s), one or two flat linerboards made from medium heavy card.

Paperboard typically has a weight of above 250 g/m², a thickness of at least 0.30 mm, is rigid, readily foldable and may be single or multi-ply. An example of a suitable paperboard is that sold by MeadWestvaco under the tradename Carrier Kote®.

If the fibrous container is to be used to be pack foodstuffs, the fibrous container is preferably formed from fibres comprising organic fibres.

Preferably, the fibrous sheets or containers (A) (prior to application of the primer layer (B) and/or the polymeric liner film (C)) comprise less than 5% by weight (preferably are substantially free of, preferably are 100% free) of plastic. In this context, plastic includes any synthetic polymer that comprises a structural element, coating, polymer fibre and/or layer (e.g. barrier layer) that forms part of the fibrous container.

Fibrous containers used to pack foodstuffs are preferably substantially free (preferably 100% free) of any components and/or additives that would be incompatible with relevant local legalisation regulating contact with food, and for example which might otherwise migrate into the foodstuff (such as certain inks, dyes and/or pigments).

Primed fibrous sheets or containers (A) as described herein comprise fibrous materials (such as paperboard and/or cartonboard) and may be used to form primed fibrous containers as described herein. The primed fibrous sheets or containers are suitable for use with polymeric liner films (C), particularly polyester liner films. The lined fibrous sheets or containers are suitable for packing of food, such as ready-prepared ovenable meals.

The polymeric liner film (C) is preferably disposed within the laminate and/or sealed package such that it provides a hermetic seal.

The product does not directly contact the surface of the fibrous container (A), which advantageously allows more choice for the components and/or additives present in the fibrous material.

Preferably, the sealed packages (and the fibrous containers used to form the sealed packages) are ovenable in a conventional or microwave oven, more preferably dual-ovenable in a conventional and microwave oven, and are capable of being heated up to conventional cooking temperatures to cook the foodstuff sealed therein. Preferably, the sealed packages (and the fibrous containers used to form the sealed packages) can be heated up to 220° C. (preferably up to 230° C., preferably up to 260° C.) in a conventional oven and/or heated up to 90° C. (preferably up to 95° C., preferably up to 100° C.) in a microwave oven, without the container substantially burning, scorching, melting and/or contaminating the contents within the container.

According to another aspect of the invention, there is provided a laminate comprising a fibrous sheet or container (A), a primer layer (B) disposed on one surface of the fibrous sheet or container, and a thermoformable and/or thermoformed polymeric liner film (C), the polymeric liner film optionally comprising a heat-sealable layer (C₁) disposed on one surface of a polymeric substrate film (C₂), wherein
a) the optional heat-sealable layer is a copolyester heat-sealable layer;
b) the primer layer is derived from a primer composition comprising at least one sulfopolyester;
   wherein the optional heat-sealable layer and the primer layer are bonded with each other to form the laminate.

Preferably, the laminate comprises a layer of fibrous sheet or container (A), a primer layer (B) derived from a primer composition comprising at least one sulfopolyester, a heat-sealable layer (C₁) of amorphous polyester and a layer of thermoformable and/or thermoformed polyester substrate film (C₂). Preferably, the layer of fibrous sheet or container (A) is bound to an adjacent primer layer (B), the primer layer (B) is also bound to an adjacent heat-sealable layer (C₁) of polyester (preferably copolyester, preferably a copolyester as described hereinabove), and the heat-sealable layer (C₁) is also bound to an adjacent layer of thermoformable and/or thermoformed polyester substrate film (C₂).

A further aspect of the invention provides use of a primer composition comprising at least one sulfopolyester, for instance in a method as described herein, for preparing a sealed package and/or container.

A further aspect of the invention provides a primed fibrous sheet or container comprising a fibrous sheet or container (A) and a primer layer (B) disposed on one surface (or part) of the fibrous sheet or container, wherein the primer layer is derived from a primer composition comprising at least one sulfopolyester. The primer layer (B) is capable of being bonded to a polymeric liner film (C), wherein the polymeric liner film (C) optionally comprises a polymeric substrate film (C₂) having thereon a heat-sealable coating (C₁). The heat-sealable coating (C₁) is preferably a polyester heat-sealable coating (preferably copolyester, preferably a copolyester as described hereinabove).

Primed fibrous sheets that comprise fibrous materials as described herein (such as paperboard and/or cartonboard) may be used to form primed fibrous containers also as described herein, and are suitable for use with polymeric liner film, particularly polyester liner films which are suitable for packing of food, such as ready-prepared ovenable meals.

A wide range of films can be used for the lidding film. Suitable lidding films are disclosed in, for instance, EP-1838526-A1, EP-2185359-A1, EP-1644265-A2, EP-1984177-A1, EP-2077943-A1 and EP-1644266-A1, the disclosures of which are incorporated herein by reference.

A further aspect of the present invention provides use of a primer composition comprising at least one sulfopolyester to prime a fibrous sheet or container (A), to form a primer layer (B) on one surface (or part thereof) of the fibrous sheet or container. The primer layer (B) is suitable for bonding to a polymeric liner film (C), preferably a polyester liner film (C). The polymeric liner film (C) optionally comprises a heat-sealable layer (C₁) which is preferably a polyester heat-sealable layer (preferably copolyester, preferably a copolyester as described hereinabove)

A further aspect of the invention provides a method of preparing a laminate or container of the invention, the method comprising the steps of:
a) providing a sheet or container of fibrous material (A);
b) applying to a surface thereof a primer composition comprising at least one sulfopolyester(s) to form a primer layer (B);
c) lining the primed sheet or primed container with a thermoformable and/or thermoformed polymeric (preferably polyester) liner film (C).

Preferably, step c) further comprises thermoforming the polyester liner.

A further aspect of the invention provides use of a primer composition comprising at least one sulfopolyester in a method described herein for preparing a sealed package having a product therein.

A further aspect of the invention provides use of a primer composition comprising at least one sulfopolyester in a method described herein for preparing a laminate or container.

A further aspect of the invention provides a sealed package having a product therein (the product preferably comprising a foodstuff, more preferably an ovenable ready-meal), the sealed package being obtained and/or obtainable by a method described herein for preparing a sealed package having a product therein.

A further aspect of the invention provides a laminate or container obtained and/or obtainable by a method described herein for preparing a laminate or container.

A further aspect of the invention provides a primed fibrous sheet or container (A) and disposed on one surface thereof (or part thereof), a primer layer (B) derived from a primer composition comprising at least one sulfopolyester. The primer layer is capable of being bonded to a polymeric liner film (C) (preferably a polyester liner film), the polymeric liner film (C) optionally comprising a (optionally heat-) sealable coating (C₁) comprising (optionally amorphous) copolyester(s).

A further aspect of the invention provides use of a primer composition comprising at least one sulfopolyester to prime a fibrous sheet or container (A), to form a primer layer (B) on one surface thereof (or part thereof). The primer layer (B) is capable of being bonded to a polymeric liner film (C) (preferably a polyester liner film), the polymeric liner film (C) optionally comprising a (optionally heat-) sealable layer (C₁) comprising (optionally amorphous) copolyester(s).

A further aspect of the invention provides a method of preparing a primed fibrous sheet or container, the method comprising the steps of:
a) applying a primer composition comprising at least one sulfopolyester to one surface (or part thereof) of the fibrous sheet or container (A); and
b) forming a primed fibrous sheet and/or container capable of being bound to a polymeric liner film (C), preferably a polyester liner film.

A further aspect of the invention provides a primed fibrous sheet or container obtained or obtainable from a method described herein for preparing a primed fibrous sheet or container.

It will be appreciated that the features and preferences described hereinabove in respect of each of the first, second, third and fourth aspects of the invention are applicable to each of the further aspects of the invention.

Preferred laminates comprise a primed fibrous container (i.e. a fibrous container (A) and a primer layer (B) disposed on said fibrous container) bonded to a heat-sealable polymeric film (preferably to heat-sealable layer (C₁) disposed on polymeric substrate film (C₂)). Preferably, the heat-sealable layer (C₁) and/or the polymeric base film (C₂) is a polyester film.

The polymeric liner film (C) imparts improved properties to the fibrous sheet or container (A) to which it is applied. Such improved properties may include: improved barrier properties (for example, to oxygen and/or water vapour) which increases product shelf life; improved resistance to liquids (such as fats, oils or water) which would otherwise be absorbed within the fibrous material and reduce the mechanical integrity of the container, and/or add undesirable taints or odours to the product contents and/or local environment; and/or reduced (or zero) leakage from the container.

The laminates of the present invention are particularly suitable to form containers that hold foodstuffs or other perishable products (such as ovenable foodstuffs (for example, ready meals) and take-away foodstuffs). For example, the laminates are particularly suitable to form containers (such as boxes) for pizza, fish and chips etc. and/or to form containers (such as boxes) to hold frozen fish.

The lined fibrous laminated sheets of the present invention may have other uses than preparing containers. For example, they may be used in applications where the liner properties (and the ability to coat such polymer liners) allows the opposite surfaces of a fibrous sheet lined on one surface only to exhibit very different properties. For example a polymeric lined surface of a lined sheet of the invention could be modified for opacity, matt level, printability, embossability and the like in a manner different from the raw fibrous surface of the opposing side of the same sheet. This ability may be useful for certain applications, for example decorative and/or security applications. Lined sheets of the invention may be used to produce lined wallpaper or other decorative sheets having aesthetically pleasing effects. The lined sheets of the invention may also be used to introduce novel security features to fibrous security documents (for example those comprising paper) such as tamper evident labels, identity documents and/or currency.

Unless the context clearly indicates otherwise, as used herein plural forms of the terms herein are to be construed as including the singular form and vice versa.

The term “comprising” as used herein will be understood to mean that the list following is non exhaustive and may or may not include any other additional suitable items, for example one or more further feature(s), component(s), ingredient(s) and/or substituent(s) as appropriate.

The term “consisting essentially of” as used herein will be understood to mean that the following list is substantially exhaustive so generally substantially comprises the listed component(s) as the substantial component(s) thereof, the list being substantially free of other component(s). Thus for example whilst a small number and/or quantity of other additional and/or suitable items may be foreseen, such items would be present to a limited extent consistent with the definitions of “suitable”, “substantially” and/or “substantially-free” as defined further herein.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of and/or used on the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises the use of polymeric films (more preferably polyester films) as liner films to produce lined fibrous containers from pre-primed fibrous sheets or containers. A further preferred utility is the preparation of a package comprising a product (such as a foodstuff) encapsulated within the lined fibrous container (more preferably a lined tray of paperboard and/or cartonboard).

In the discussion of the invention herein, unless stated to the contrary, the disclosure of alternative values for the upper and lower limit of the permitted range of a parameter coupled with an indicated that one of said values is more preferred than the other, is to be construed as an implied statement that each intermediate value of said parameter, lying between the more preferred and less preferred of said alternatives is itself preferred to said less preferred value and also to each less preferred value and said intermediate value.

For all upper and/or lower boundaries of any parameters given herein, the boundary value is included in the value for each parameter. It will also be understood that all combinations of preferred and/or intermediate minimum and maximum boundary values of the parameters described herein in various embodiments of the invention may also be used to define alternative ranges for each parameter for various other embodiments and/or preferences of the invention whether or not the combination of such values has been specifically disclosed herein.

Thus for example a substance stated as present herein in an amount from 0 to “x” (e.g. in units of mass and/or weight %) is meant (unless the context clearly indicates otherwise) to encompass both of two alternatives, firstly a broader alternative that the substance may optionally not be present (when the amount is zero) or present only in an de-minimus amount below that can be detected. A second preferred alternative (denoted by a lower amount of zero in a range for amount of substance) indicates that the substance is present, and zero indicates that the lower amount is a very small trace amount for example any amount sufficient to be detected by suitable conventional analytical techniques and more preferably zero denotes that the lower limit of amount of substance is greater than or equal to 0.001 by weight % (calculated as described herein).

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non exhaustive the sum of the percentage for each of such components may be less than 100% to allow a certain percentage for additional amount(s) of any additional component(s) that may not be explicitly described herein.

In the present invention, unless the context clearly indicates otherwise, an amount of an ingredient stated to be present in the composition of the invention when expressed as a weight percentage, is calculated based on the total amount of components (such as monomers) in the composition being equivalent to 100% (thus for example the sum of components (a)+(b)+(c)+(d) etc. is 100%). For convenience certain ingredients (such as for example which fall outside the definitions of any of components (a) to (d) etc. may also be calculated as weight percentages based on total components (such as monomer) i.e. where the total weight of those components alone is set at 100%, which will mean in that case the total percentages will exceed 100% and weight percentages can be considered as providing a ratio for the weight amounts for these ingredients with respect to the total weight of components (such as monomers) which is used only as a reference for calculation rather than as a strict percentage.

The term “substantially” as used herein may refer to a quantity or entity to imply a large amount or proportion thereof. Where it is relevant in the context in which it is used “substantially” can be understood to mean quantitatively (in relation to whatever quantity or entity to which it refers in the context of the description) there comprises an proportion of at least 80%, preferably at least 85%, more preferably at least 90%, most preferably at least 95%, especially at least 98%, for example about 100% of the relevant whole. By analogy the term “substantially-free” may similarly denote that quantity or entity to which it refers comprises no more than 20%, preferably no more than 15%, more preferably no more than 10%, most preferably no more than 5%, especially no more than 2%, for example about 0% of the relevant whole.

Preferred compositions of and/or used in the present invention, may exhibit comparable properties (compared to known compositions and/or components thereof) in two or more, preferably three or more, most preferably in the rest of those properties described herein. Comparable properties as used herein means the value of the component and/or composition of and/or used in the present invention is within +/−6% of the value of the known reference component and/or composition described herein, more preferably +/−5%, most preferably +/−4%.

The percentage differences for comparable properties herein refer to fractional differences between the component and/or composition of and/or used in the invention and the known reference component and/or composition described herein where the property is measured in the same units in the same way (i.e. if the value to be compared is also measured as a percentage it does not denote an absolute difference).

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination. Many other variations embodiments of the invention will be apparent to those skilled in the art and such variations are contemplated within the broad scope of the present invention.

Further aspects of the invention and preferred features thereof are given in the claims herein.

### THE INVENTION IS ILLUSTRATED BY THE FOLLOWING NON-LIMITING FIGURE WHERE

FIG. 1 is bar chart plotting the lamination bond strength of various comparative laminates and laminates of the invention as described below.

### PROPERTY MEASUREMENT

The following analyses were used to characterize the laminates described herein:
(i) Intrinsic viscosity (in units of dL/g) of the polyester and polyester film is measured by solution viscometry in accordance with ASTM D5225-98(2003) on a Viscotek™ Y-501 C Relative Viscometer (see, for instance, Hitchcock, Hammons & Yau in American Laboratory (August 1994) “The dual-capillary method for modern-day viscometry”) by using a 0.5% by weight solution of polyester in o-chlorophenol at 25° C. and using the Billmeyer single-point method to calculate intrinsic viscosity:

η=0.25η_{red}+0.75(ln ηᵣₑₗ)/c
wherein:
η=the intrinsic viscosity (in dL/g),
ηᵣₑₗ=the relative viscosity,
c=the concentration (in g/dL), &
η_{red}=reduced viscosity (in dL/g), which is equivalent to (ηᵣₑₗ−1)/c
(also expressed as nsp/c where nsp is the specific viscosity).
(ii) Lamination bond strength is measured by the following procedure. The polymeric liner film is sealed (where present, by means of the heat-sealable layer) to a container or, where present, to a primer layer which is disposed on said container. Sealing is effected by using a Sentinel heat-seal machine at a temperature of 140° C., and pressure of 30 psi for 1 sec. Strips (25 mm) of the sealed liner film and tray are cut out and undergo a 180° peel test. The load required to pull the seal apart measured using an Instron Model 4301 operating at a crosshead speed of 250 mm/min. The procedure is repeated and a mean value of results calculated.
(iii) Molecular weight is measured by GPC performed on a Malvern/Viscotek TDA 301 using an Agilent PL HFIPgel guard column plus 2×30 cm PL HFIPgel columns. A solution of HFIP with 25 mM NaTFAc was used as eluent, with a nominal flow rate of 0.8 mL min⁻¹. All experimental runs were conducted at 40° C., employing a refractive index detector. Molecular weights are referenced to polymethylmethacrylate calibrants. Data capture and subsequent data analysis were carried out using Omnisec software. Samples were prepared at a concentration of 2 mg mL⁻¹, with 20 mg of sample dissolved in 10 mL eluent. These solutions were stirred for 24 h at room temperature and then warmed at 40° C. for 30 mins to fully dissolve the polymer. Each sample was filtered through a 0.45 μm polytetrafluoroethylene membrane prior to injection. It will be appreciated that once the M_{w} and Mₙ values are known, the PDI may be determined.
(iv) Glass transition temperature is measured by Differential Scanning Calorimetry (DSC). A 10 mg polymer specimen taken from the film is dried for 12 hours under vacuum at 80° C. The dried specimen is heated at 290° C. for 2 minutes and then quenched onto a cold block. The quenched specimen is heated from 0° C. to 290° C. at a rate of 20° C./minute using a Perkin-Elmer DSC7B. The glass transition temperature quoted is onset.

### EXAMPLES

The invention is further illustrated by the following examples. It will be appreciated that the examples are illustrative only and are not intended to limit the scope of the invention as described herein. Unless otherwise specified all parts, percentages, and ratios are on a weight basis. The prefix C before an example indicates that it is comparative example.

In the examples, coated polymeric liner films were prepared as follows. An uncoated thermoformable transparent biaxially oriented PET-based copolyester film with a thickness of 25 μm was used as the polymeric substrate film (C₂), which is commercially available from DuPont Teijin Films under the trade designation Mylar® P25. A heat-sealable layer (C₁) was coated on one surface of the film. The heat-sealable layer comprised an amorphous copolyester derived from ethylene glycol, terephthalic acid and azelaic acid.

A primer composition (B) was then prepared. The primer composition comprised an aqueous dispersion of a sulfopolyester derived from 5-sodium sulfo-isophthalic acid, in an aqueous solution containing 2% n-propanol and 30 wt % solids and a Cymel® crosslinking agent. A thin continuous coating of the primer composition was applied directly to the surface of a fibrous sheet (A). Thus, a primer coating layer was formed. The mean thickness of the primer coating was in the range of 20 nm to 5 μm. The primer compositions and sheets used in each case are detailed in the specific examples.

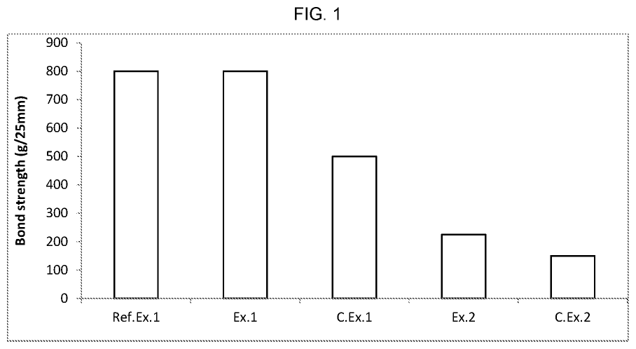

In the following examples, the polymeric liner film was bonded, via the heat-sealable coating layer (C₁) to the fibrous or APET sheet, via the primer layer (B) where present. The lamination bond strength between the sheet and the heat-sealable layer of the polymeric liner film was assessed. The results are provided in FIG. 1.

### Reference Example 1

Reference Example 1 was prepared from a conventional APET sheet. The APET sheet was directly bound to the heat-sealable coating layer of the polymeric liner film described above. Thus, the laminate had an AC₁C₂-layer structure, wherein layer A is the APET sheet, layer C₁ is the heat-sealable coating layer and layer C₂ is the polymeric substrate film.

### Example 1

In this example, Invercote G was used as the fibrous sheet. Invercote G is a paperboard which is commercially available from Iggesund Paperboard. The primer composition and polymeric liner film was as described above. Thus, the laminate had an ABC₁C₂-layer structure, wherein layer A is the fibrous sheet, layer B is the primer layer, layer C₁ is the heat-sealable coating layer and layer C₂ is the polymeric substrate film.

### Comparative Example 1

Invercote G was used as the fibrous sheet and the polymeric liner film was as described above. However, no primer layer was used. Thus, the laminate had an AC₁C₂-layer structure.

### Example 2

In this example, Everest™ was used as the fibrous sheet. Everest™ is a cartonboard which is commercially available from Graphic Packaging International. The primer composition and polymeric liner film was as described above. Thus, the laminate had an ABC₁C₂-layer structure.

### Comparative Example 2

Everest™ was used as the fibrous sheet and the polymeric liner film was as described above. However, no primer layer was formed. Thus, the laminate had an AC₁C₂-layer structure.

### Results

FIG. 1 shows the effect that primer layer (B) had on the lamination bond strength. The laminates of the inventive Examples 1 and 2 exhibit an advantageously strong lamination bond strength relative to the comparative laminates of Comparative Examples 1 and 2 respectively. In particular, the laminate of Example 1 exhibited optimal binding between the polymeric liner film and the sheet, and the lamination bond strength exhibited was similar to the lamination bond strength exhibited by the commercially available APET sheet of Reference Example 1.

The laminates of the present invention were formed into containers which, after a suitable lidding film was applied, provided leak-free hermetically sealed packages. Additionally, once the package has been used, the polymeric liner film was found advantageously to be readily removed from the fibrous container.

1. A method for preparing a laminate, the method comprising the steps of:
a) providing a container or sheet (A) which comprises a fibrous material;
b) disposing a primer composition onto at least one surface of the container or sheet to form a primer layer (B) on the container or sheet, wherein the primer composition comprises at least one sulfopolyester;
c) disposing a polymeric liner film (C) onto a surface of the primer layer (B), to form a lined container or sheet, wherein the polymeric liner film comprises a polymeric substrate film (C₂) and a heat-sealable layer (C₁), wherein the heat-sealable layer is formed from a PET-based copolyester;
d) where a lined sheet is obtained from step c), optionally forming (preferably thermoforming) a lined container from the lined sheet,
wherein the laminate consists of the container or sheet (A), the primer layer (B), the heat-sealable layer (C₁) and the polymeric substrate film (C₂).

2. A laminate consisting of a container or sheet (A), a primer layer (B) disposed on at least one surface of the container or sheet, and a polymeric liner film (C) disposed on the primer layer, wherein the container or sheet (A) comprises a fibrous material, wherein primer layer (B) is derived from a primer composition comprising at least one sulfopolyester, and wherein the polymeric liner film comprises a polymeric substrate film (C₂) and a heat-sealable layer (C₁), wherein the heat-sealable layer is formed from a PET-based copolyester.

3. A method for preparing a sealed package, wherein the package comprises a product encapsulated within a lined container which is sealed with a polymeric lidding film, the method comprising the steps of:
a) providing a container or sheet (A) which comprises a fibrous material;
b) disposing a primer composition onto at least one surface of the container or sheet (A) to form a primer layer (B) on the container or sheet, wherein the primer composition comprises at least one sulfopolyester;
c) disposing a polymeric liner film (C) onto a surface of the primer layer (B) to form a lined sheet or lined container;
d) where a lined sheet is obtained from step c), forming (preferably thermoforming) a lined container from the lined sheet;
e) placing a product within the lined container obtained from step c) or d);
f) bonding a polymeric lidding film to the lined container with product therein obtained from step e) in order to obtain a sealed package.

4. A sealed package comprising a product encapsulated within a lined container which is sealed with a polymeric lidding film, wherein the lined container comprises a container (A), a primer layer (B) disposed on at least one surface of the container, and a polymeric liner film (C) disposed on the primer layer, wherein the container (A) comprises a fibrous material and wherein primer layer (B) is derived from a primer composition comprising at least one sulfopolyester.

5. A method as claimed in claim 1 or claim 3, wherein step d) comprises thermoforming a lined container from the lined sheet.

6. A method as claimed in claim 5, wherein steps c) and d) occur simultaneously, such that the heat and pressure applied during the thermoforming step softens the polymeric liner film to a sufficient extent that it forms a bond to the surface of the primer layer (B).

7. A method as claimed in claim 3, or a sealed package as claimed in claim 4, wherein the product comprises a foodstuff.

8. A method or sealed package as claimed in claim 7, wherein the foodstuff is ovenable.

9. A method or sealed package as claimed in claim 8, wherein the ovenable foodstuff is a ready-meal.

10. A method or sealed package according to claim 3 or 4, or according to any of claims 5 to 10 when dependent from claim 3 or 4, wherein the polymeric liner film (C) comprises, or consists of, a polymeric substrate film (C₂).

11. A method or laminate according to claim 1 or 2, or a method or sealed package as claimed in claim 10 wherein the polymeric substrate film comprises polyethylene terephthalate (PET), polyethylene 2,6⁻naphthalate (PEN), copolyesters comprising (or consisting) of monomeric units derived from terephthalic acid, at least one aliphatic dicarboxylic acid and at least one diol, polylactic acid (PLA), polyethylene furanoate (PEF) and/or polyhydroxybutyrate (PHB), or wherein the polymeric substrate film comprises polyethylene terephthalate or polyethylene naphthalate.

12. A method or laminate according to claim 1 or 2, or a method or sealed package as claimed in claim 10 wherein the polymeric substrate film comprises, and preferably is, a copolyester film wherein the copolyester is derived from:
(i) one or more diol(s);
(ii) an aromatic dicarboxylic acid; and
(iii) one or more aliphatic dicarboxylic acid(s) of the general formula CₙH₂ₙ(COOH)₂ wherein n is 2 to 10, preferably 4 to 10,
wherein the aliphatic dicarboxylic acid is present in the copolyester in an amount of from about 1 to about 20 mol %, preferably from about 1 to 10 mol %, preferably from about 3 to about 10 mol %, based on the total amount of dicarboxylic acid components in the copolyester, preferably wherein the aromatic dicarboxylic acid is selected from terephthalic acid, isophthalic acid, phthalic acid, 2,5-, 2,6- or 2,7-naphthalenedicarboxylic acid, and is preferably terephthalic acid; preferably wherein the diol is selected from aliphatic and cycloaliphatic glycols, preferably from aliphatic glycols and is preferably ethylene glycol; and preferably wherein the aliphatic dicarboxylic acid is saturated and preferably selected from succinic acid, glutaric acid, adipic acid, pimelic acid, suberic acid, azelaic acid and sebacic acid, preferably from succinic acid, adipic acid, azelaic acid and sebacic acid, and preferably is azelaic acid.

13. A method, laminate or sealed package as claimed in any of claims 1 to 2 or 10 to 12 wherein the polymeric substrate film is a thermoformable film.

14. A method, laminate or sealed package as claimed in any one of claims 1 to 2 or 10 to 13, wherein the polymeric substrate film is uniaxially or biaxially oriented, preferably biaxially oriented.

15. A method, laminate or sealed package as claimed in any one of claims 10 to 14 when dependent from claim 3 or 4, wherein the polymeric liner film further comprises a heat-sealable layer (C₁).

16. A method, laminate or sealed package as claimed in claim 1, 2 or 15, wherein the heat-sealable layer (C₁) is disposed on the polymeric substrate film (C₂) such that the heat-sealable layer (C₁) is in direct contact with both the polymeric substrate film (C₂) and primer layer (B) in the laminate or sealed package.

17. A method, laminate or sealed package as claimed in claim 1, 2 or 15 to 16, wherein the heat-sealable layer is a coating layer.

18. A method, laminate or sealed package as claimed in any of claims 15 to 17 when dependent from claim 3 or 4, wherein the heat-sealable layer is a PET-based copolyester heat-sealable layer.

19. A method or laminate as claimed in claim 1 or 2, or a method or sealed package as claimed in claim 18, wherein the heat-sealable layer is an amorphous PET-based copolyester heat-sealable layer.

20. A method, laminate or sealed package as claimed in any one of claims 1, 2 or 15 to 19 wherein the polymer of the heat-sealable layer is one or more copolyester(s) derived from an aliphatic glycol (preferably ethylene glycol), a first dicarboxylic acid (preferably terephthalic acid) and a second dicarboxylic acid (preferably isophthalic acid or azelaic acid).

21. A method, laminate or sealed package as claimed in any of claims 1, 2 or 15 to 19, wherein the heat-sealable layer softens at a temperature such that a heal-seal bond can be formed at a temperature which is from about 5° C. to about 100° C. below the melting temperature of the polymeric substrate film and the primer layer.

22. A method, laminate or sealed package as claimed in any one of claims 1 to 21, wherein the polymeric liner film is a thermoformable and/or thermoformed polymeric liner film.

23. A method, laminate or sealed package as claimed in any one of claims 1 to 22, wherein the container or sheet comprises paperboard and/or cartonboard.

24. A method, laminate or sealed package as claimed in claim 23, wherein the container or sheet comprises a paperboard tray.

25. A method, laminate or sealed package as claimed in any preceding claim, wherein the primer composition comprises an aqueous coating vehicle.

26. A method, laminate or sealed package as claimed in any preceding claim, wherein the sulfopolyester is derived from 5-sodium sulfo-isophthalic acid and/or or dimethyl 5-sodium sulfo-isophthalate.

27. A method, laminate or sealed package as claimed in claim 26 wherein the primer composition comprises the sulfopolyester in an amount of about 25% to about 35% by weight based on the total weight of the sulfopolyester and the coating vehicle.

28. Use of a primer composition comprising at least one sulfopolyester in a method as claimed in claim 3, or in any one of claims 5 to 27 when dependent from claim 3, for preparing a sealed package.

29. A sealed package having a product therein and obtained and/or obtainable by a method as claimed in claim 3 or any one of claims 5 to 28 when dependent from claim 3.

30. A laminate obtained and/or obtainable by a method as claimed in any of claim 1 or any one of claims 10 to 27 when dependent from claim 1.
